(19) United States
(12) Patent Application Publication
(10) Pub. No.: US 2004/0246740 A1
(43) Pub. Date: Dec. 9, 2004

(54) Pulsating brake lights

(76) Inventor: Andrzej Rogalski, Rockwood (CA)

Correspondence Address: Andrzej Rogalski, R.R. # 5 Hwy 7 #8191, Rockwood, ON, N0B 2K0, CA

(21) Appl. No.: 10/454,067

(22) Filed: Jun. 5, 2003

(51) Int. Cl. B60Q 1/26

(52) U.S. Cl. 362/541

(57) ABSTRACT

I realized that our society pays more and more attention to safety. Therefore, I decided to follow this trend by focusing specifically on safety of driving. The most important aspect of driving is being able to stop or apply brakes. However, if other drivers are unaware we are in the process of doing that, or if they do not pay enough attention, our safety is at risk. Having said all that, our reaction is based on what we see. On the road, we know that a vehicle in front of us is applying brakes when the red light comes on. However, that red light can be easily missed or confused with other lights on a vehicle. Why did we come up with an idea of pulsating signal lights but the same suggestion was not made for brake lights? Imagine yourself driving behind a vehicle when suddenly its red braking lights are starting to flash. Instantly, you react and your awareness is awaken. As an added benefit pulsating lights are more visible in any type of weather or driving conditions.

### CROSS-REFERENCE TO RELATED APPLICATIONS

N/A

### BACKGROUND OF THE INVENTION

Based on my driving experience of over 25 years as well as the driving experiences of my family and friends I have realized that steady brake lights can be easily confused with other vehicle lights especially at evenings when tail-lights are on. I have observed that many drivers jam on the brakes unexpectedly and a driver behind this vehicle hasn't noticed that brakes are applied. As a result cars pile up sometimes in big numbers.

### BRIEF SUMMARY OF THE INVENTION

I have the idea to increase safety of driving on the roads by adding a small electronic module to the brake lights in every vehicle moving on public roads as well as on off-road vehicles.

The proposed electronic module will pulse brake lights 60-100 times per minute. That will make brake lights more visible and bring more awareness to other drivers.

### DETAILED DESCRIPTION OF THE INVENTION

The electronic module I propose will pulse brake lights 60-100 times per minute. This module can be installed on a vehicle by adding it to main brakes power line branch, or to hi-current relay itself.

Existing automotive electric-hydraulic braking systems contain only hi-current electric relay designed to provide steady electric-current to the brake lights bulbs.

By adding a few electronic components to the electric-relay it will make brake light pulsate. Also a separate small electronic module can be built and installed to the main current brake electric wire. That solution maybe applied to older vehicles.

Brake lights pulsating frequency I have chosen is 60-100 Hz (pulses per minute). It will increase awareness even if a driver of a following vehicle didn't pay full attention to the road situation. Yet it will be very visible in every existing weather condition.

1. What I claim as my invention is an idea to have pulsating brake lights on every vehicles moving on public roads as well as on off-road vehicles.
